(19) United States
(12) Patent Application Publication
(10) Pub. No.: US 2015/0123412 A1
(43) Pub. Date: May 7, 2015

(54) DOOR GUARD FOR VEHICLE

(71) Applicant: Dong Cheol KIM, Gangwon-do (KR)

(72) Inventor: Dong Cheol KIM, Gangwon-do (KR)

(21) Appl. No.: 14/533,352

(22) Filed: Nov. 5, 2014

(30) Foreign Application Priority Data
Nov. 7, 2013 (KR) 20-2013-0009137

(51) Int. Cl. B60R 13/04

(52) U.S. Cl. CPC B60R 13/04
USPC 293/128

(57) ABSTRACT

A door protector for a vehicle is mounted on the external surface of a door of the vehicle to protect the coated layer on the door or a vehicle body from damages occurring by outside impacts or scratches. The door protector for a vehicle includes: a body having a shape of an elongated band having a length corresponding to the width of a vehicle door in left and right sides; hooks fixedly mounted on both ends of the body in such a manner as to be locked in a hook shape onto both ends of the door; cushions fixedly disposed on the body in the longitudinal direction of the body to conduct impact absorption; and a rubber magnet disposed in the longitudinal direction of the body to allow the body to be attached to the surface of the door by means of a magnetic force generated therefrom.

### CROSS REFERENCE

This application claims foreign priority under Paris Convention to Korean Patent Application No. 20-2013-0009137, filed 7 Nov. 2013, with the Korean Intellectual Property Office.

### BACKGROUND

The present invention relates to a door protector for a vehicle, and more particularly, to a door protector for a vehicle that is mounted on the external surface of a door of the vehicle to protect the coated layer on the door or a vehicle body from damages occurring by outside impacts or scratches.

In the process of opening and closing a door of a vehicle, the external surface of the door often collides against an outside wall or other vehicles to cause the coated layer on the door to be peeled off and even to cause a door panel to be depressedly damaged. Such damages occurring on the coated layer and the door panel remain permanently, so that the coated layer and the door panel cannot be returned to their original states unless sheet metal working and coating for them are carried out. So as to protect the door or the body of the vehicle from such damages, accordingly, a door protector for a vehicle (hereinafter, referred simply to as ‘door protector’) is bonded to the external surface of the door by means of an adhesive. The conventional door protector is generally called ‘door guard’. Most of the conventional door protectors are made of a cushion material like a sponge, and they are generally attached to doors for new vehicles before shipped. The conventional door protector has a shape of a general hexahedron, and further, door protectors having various shapes have been proposed to improve a quality of the outer appearance thereof.

However, the conventional door protectors are limited in their application ranges. That is, they are generally attached to the edges of the doors since the edges of the doors may be brought into first contact with neighboring objects in the process of opening the doors. Accordingly, the conventional door protectors protect other's vehicles as well as doors to which they are attached from external impacts or scratches.

While the door of the neighboring vehicle is being open, however, it may arbitrarily come into contact with the vehicle using the conventional door protector. This results from various door heights and parking positions. If there is no protector on the door of the neighboring vehicle, accordingly, the door of the vehicle using the conventional door protector may be damaged. Such damages generally occur in a small parking lot, and further, when they happen, it is hard to witness them and even to receive the compensation for them. If such damages repeatedly happen, the door remains in a severely damaged state.

On the other hand, the conventional door protector protrudes outward from the door of the vehicle irrespective of the whole beauty of the vehicle, which undesirably receives air resistance and decreases the quality of the outer appearance of the vehicle. Accordingly, there is proposed Korean Patent Application No. 10-2011-0112065 entitled ‘active electronic type vehicle door guard device’, wherein if the vehicle door guard device is needed, it is exposed electronically to the outside, and if not needed, it is hidden electronically.

As another example of the conventional door protector, further, there is proposed Korean Patent Application No. 10-2011-0039375 disclosing a vehicle door guard having a light emitting device.

The above-mentioned conventional door protectors are proposed to improve their functions, but fail to achieve the objects intended by this inventor. That is, they still have the problem in the restriction in the range of protecting the vehicle door from external impacts or scratches.

### SUMMARY OF THE INVENTION

Accordingly, the present invention has been made in view of the above-mentioned problems occurring in the prior art, and it is an object of the present invention to provide a door protector for a vehicle that is capable of protecting the entire range of a vehicle door from external impacts or scratches, while providing relatively low manufacturing cost, good durability and many conveniences in use.

It is another object of the present invention to provide a door protector for a vehicle that is capable of enhancing sight effects when mounted, reducing air resistance, and being selectively used when needed since it is easily installed and removed.

To accomplish the above-mentioned objects, according to the present invention, there is disposed a door protector for a vehicle including: a body having a shape of an elongated band having a length corresponding to the width of a door of the vehicle in left and right sides; hooks fixedly mounted directly or indirectly on both ends of the body in such a manner as to be locked in a hook shape onto both ends of the door; cushions fixedly disposed on the body in the longitudinal direction of the body to conduct impact absorption; and a rubber magnet disposed in the longitudinal direction of the body to allow the body to be attached to the surface of the door by means of a magnetic force generated therefrom.

According to the present invention, desirably, the door protector further includes an elastic band disposed on the center of the body or on the ends of the body in such a manner as to be elastically extended in the longitudinal direction of the body.

According to the present invention, desirably, the door protector further includes a handle disposed at one side of the body to allow each hook to be mounted on the door, without having any need to hold the hook by a user's hand.

According to the present invention, desirably, the door protector further includes a protection sheet disposed on the surface coming into contact with the door to protect the surface of the door.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a door protector for a vehicle according to a first embodiment of the present invention;

FIG. 2 is a sectional view taken along the line A-A of FIG. 1;

FIG. 3 is a sectional view taken along the line B-B of FIG. 1;

FIG. 4 is a perspective view showing a door protector for a vehicle according to a second embodiment of the present invention;

FIG. 5 is a front view showing the state wherein the door protector for a vehicle according to the present invention is mounted on a door; and

FIG. 6 is a perspective view showing a hook of the door protector for a vehicle according to the present invention.

### DETAILED DESCRIPTION OF THE PREFERRED EMBODIMENTS

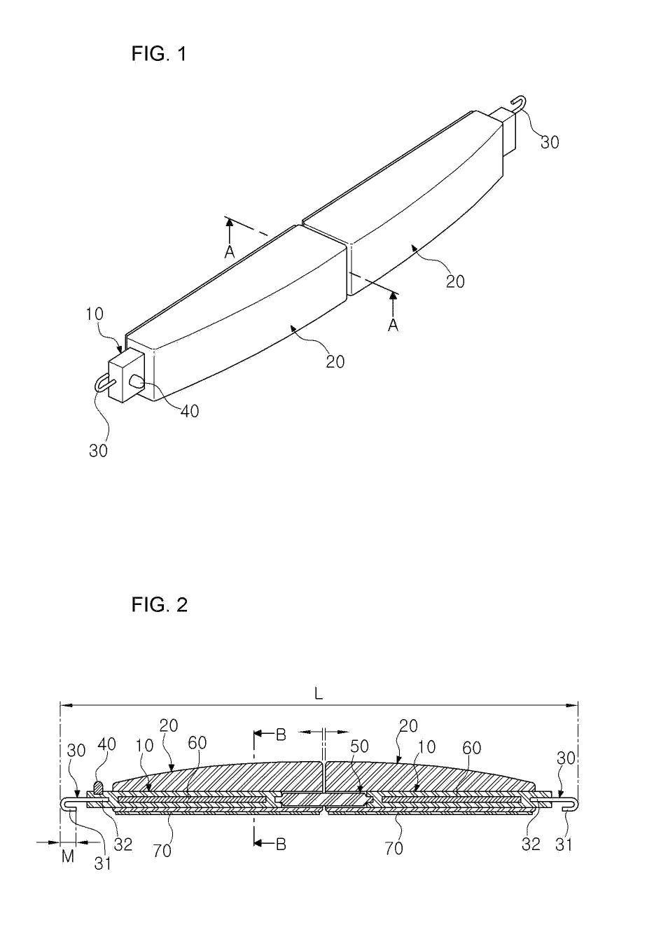

Hereinafter, an explanation on a door protector for a vehicle according to the present invention will be in detail given with reference to the attached drawings. Basically, the door protector for a vehicle according to the present invention will be described with reference to FIGS. 1 to 3, but if necessary, the explanation will be given with reference to other attached drawings.

The door protector for a vehicle according to the present invention is attached to the surface of door of the vehicle if necessary to protect a vehicle body from external impacts or contacts, and the door protector includes a body 10, hooks 30, a rubber magnet 60 and cushions 20.

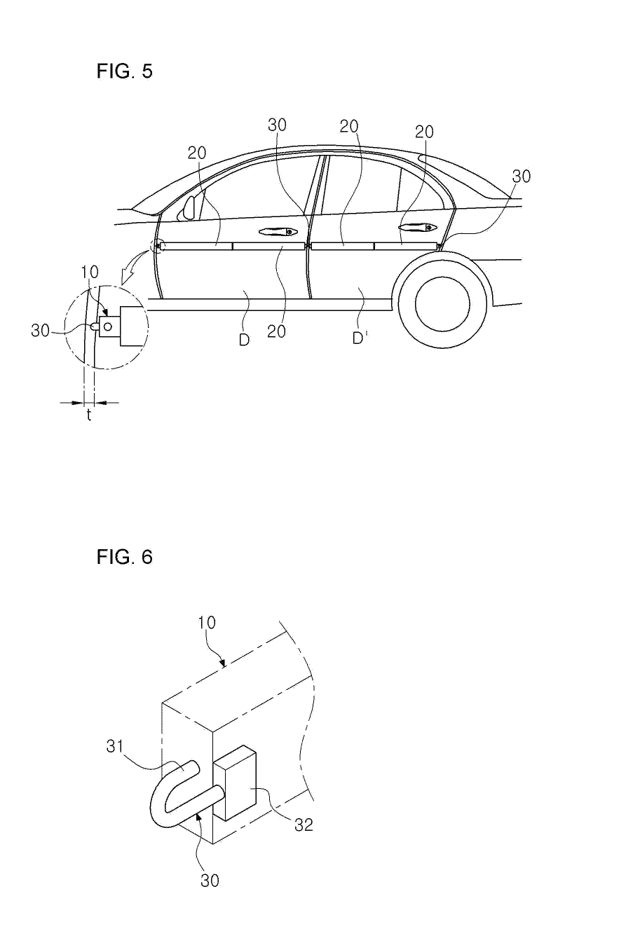

The body 10 has a shape of an elongated band having a length corresponding to the width of a vehicle door D (see FIG. 5) in left and right sides. The body 10 has width and thickness a general waist belt has and is desirably made of a flexible material so that it can be brought into close contact with the curved outer surface of the door D. For instance, the body 10 is made of a synthetic resin or fabric.

The hooks 30 are fixedly mounted on both ends of the body 10 in such a manner as to allow the body 10 to be locked in a hook shape onto both end portions of the door D as shown in FIG. 5. Each hook 30 is made of a metal material and has a bent portion 31 formed to a shape of U or C on the end portion thereof. The outer surface of the hook 30 is coated with silicon or rubber to protect the surface of the door D. The hook 30 has a root 32 inserted into the inside of the body 10, and as shown in FIG. 6, further, the root 32 has an expanded section to enhance the tension strength thereof.

According to the present invention, desirably, a length M (see FIG. 2) of the bent portion 31 of each hook 30 is longer by 2 to 5 mm than a gap t (see FIG. 5) between the door D and the body of the vehicle. This prevents the hook 30 from being easily removed by someone having bad intention in the state where the door protector of the present invention is mounted.

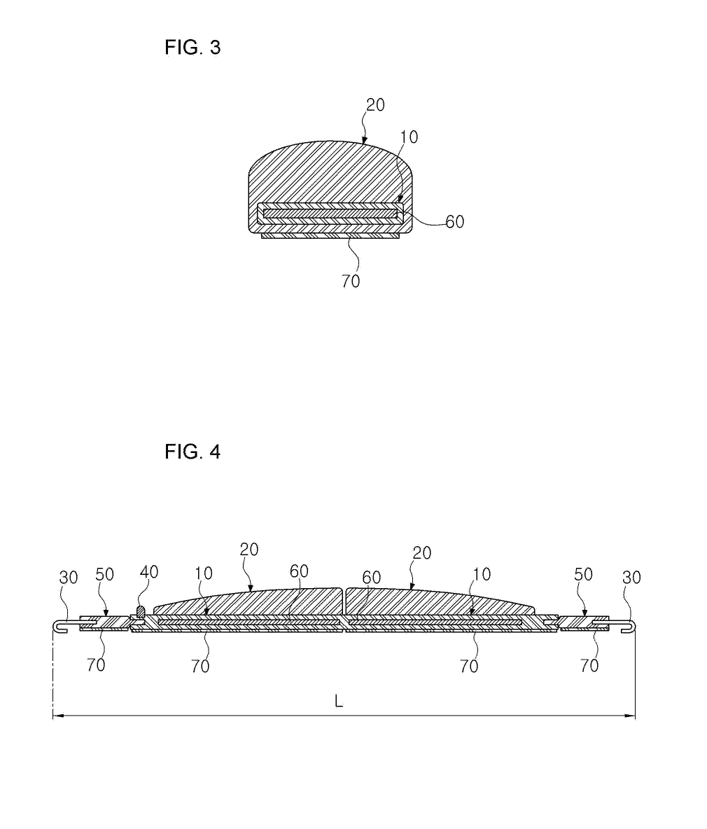

The cushions 20 are fixedly disposed on the body 10 in the longitudinal direction of the body 10 to conduct shock absorption. The cushions 20 are disposed to surround the body 10, and otherwise, they are attached to the top surface of the body 10. That is, as shown in FIG. 2, a tunnel is formed in the longitudinal direction of each cushion 20, and next, the body 10 is fixedly fitted to the tunnels of the cushions 20 to allow the cushions 20 to surround the body 10. The cushions 20 are desirably streamlined to reduce air resistance (see FIGS. 2 and 3). The cushions 20 may be formed as one unitary body, but as shown, two cushions 20 are disposed so that if one cushion 20 is damaged, it is easily exchanged with new one.

The cushions 20 may be freely varied in thickness or design with aesthetic elements. The cushions 20 may be selected in accordance with a user's preference or the design of his or her vehicle. The cushions 20 are desirably made of foamed urethane, but of course, they may be made of various materials.

If the body 10 is made of a shock absorbing material or has a shape capable of absorbing shocks, there is no need to attach the cushions 20 to the body 10.

According to the present invention, the rubber magnet 60 is disposed in the longitudinal direction of the body 10 to allow the body 10 to be attached to the surface of the door D by means of a magnetic force generated therefrom. The rubber magnet 60 also has a shape of a thin band. As shown, the rubber magnet 60 is inserted into the body 10, but of course, it may be bonded to one surface of the body 10, especially, the surface of the body 10 facing the door D. The rubber magnet 60 may be disposed over the entire section of the body 10 or only on a portion of the body 10 in the longitudinal direction of the body 10.

According to the present invention, an elastic band 50 is inserted into an arbitrary section of the body 10 in the longitudinal direction of the body 10. As shown in FIG. 2, the elastic band 50 is located at the center of the body 10, and as shown in FIG. 4, the elastic band 50 is located at one side or both sides of the body 10. In this case, the hooks 30 are indirectly connected to the body 10 through the elastic bands 50 as shown in FIG. 4.

The entire length L of the door protector of the present invention can be elastically extended by means of the elastic band 50. As shown in FIG. 2, the cushion 20 may be disposed even on the portion where the elastic band 50 is located, but in this case, the cushion 20 is desirably not bonded to the elastic band 50.

On the other hand, a safety handle 40 is disposed at one side of the door protector, especially around one side hook 30, to allow the door protector to be directly mounted on the door D, without having any need to hold the hook 30 by a user's hand. The handle 40 is formed integrally to the top surface of the body 10. The formation of the handle 40 prevents the user's hand from being caught to the gap between the door D and the vehicle body when the hook 30 is fitted to the gap. In this case, one side of the body 10 where the handle 40 is formed is located at the front side of the door D (see FIG. 5).

According to the present invention, a protection sheet 70 made of a non-woven fabric is further disposed on the underside surface of the door protector of the present invention, that is, the surface of the door protector coming into contact with the door D, to protect the surface of the door D. the protection sheet 70 serves to protect the coated layer of the door D from scratches.

Under the above-mentioned configuration, the cushions 20 can be rigidly fixed to the external surface of the door by means of the hooks 30, the elastic band 50 and the rubber magnet. If necessary, the door protector can be easily mounted or removed. If the door protector is needed, for example, if a user's vehicle is parked on a small parking lot, if the user's vehicle is driven on a downtown road, if the user is a beginner driver, the door protector is mounted on the door to protect the door from unexpected accidents. On the other hand, if the door protector is not needed, the user can drive his or her vehicle in the original state of the vehicle wherein the door protector is removed from the door.

Further, the door protector according to the present invention is advantageously mounted at an arbitrary height of the door of the vehicle, so that it can be freely used irrespective of the kinds of vehicles. Even if the door protector is completely removed and thrown away when not used anymore, no adhesive remains on the external surface of the door, which enables the door and the vehicle body to be cleanly maintained.

As mentioned above, the door protector for the vehicle according to the present invention has the shape of the band fixed horizontally to the external surface of the door, so that even if impacts are applied to arbitrary positions of the door, they can be absorbed by the door protector.

Further, the door protector for the vehicle according to the present invention is fixed to the door by means of the rubber magnet and the hooks in such a manner as to be easily mounted and removed on and from the door.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A door protector for a vehicle comprising:
a body having a shape of an elongated band made of a flexible material and having a length corresponding to the width of a door of the vehicle in left and right sides;
hooks fixedly mounted directly or indirectly on both ends of the body in such a manner as to be locked in a hook shape onto both ends of the door, each hook having a bent portion having a length longer by 2 to 5 mm than a gap between the door and a body of the vehicle;
cushions fixedly disposed on the body in the longitudinal direction of the body to conduct impact absorption;
a rubber magnet disposed in the longitudinal direction of the body to allow the body to be attached to the surface of the door by means of a magnetic force generated therefrom;
an elastic band disposed on the center of the body or on the ends of the body in such a manner as to be elastically extended in the longitudinal direction of the body;
a handle disposed at one side of the body to allow each hook to be mounted on the door, without having any need to hold the hook by a user's hand; and
a protection sheet disposed on the surface coming into contact with the door to protect the surface of the door.
